(19) United States
(12) Patent Application Publication
(10) Pub. No.: US 2003/0210699 A1
(43) Pub. Date: Nov. 13, 2003

(54) Extending a network management protocol to network nodes without IP address allocations

(75) Inventors: Jefferson Logan Holt SR., Wake Forest, NC (US); Melvin Richard Phillips, Youngsville, NC (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/142,010

(22) Filed: May 8, 2002

(51) Int. Cl. H04L 12/56

(52) U.S. Cl. 370/400; 709/223

(57) ABSTRACT

A system and method for extending a simple network management protocol (SNMP), or other IP network management messaging protocol to one or more non-IP addressed nodes includes a gateway agent addressable by an IP address, at least one non-IP addressed agent to receive and respond to network management messages; and a process for routing network management messages to and from one or more one non-IP addressed agents based on a unique identifier contained in the message.

### TECHNICAL FIELD

Embodiments of the present invention are related in general to networks and network systems and more particularly to a method for extending Simple Network Management Protocol (SNMP) or other IP network monitoring, management and control protocols to network nodes for which there are no Internet Protocol (IP) addresses.

### BACKGROUND INFORMATION

Networking protocols are normally developed in layers, with each layer responsible for a different aspect of the communications. A protocol suite, such as Transport Control Protocol/Internet Protocol, TCP/IP, is the combination of different protocols at various layers. TCP/IP is normally considered to be a 4-layer system, as shown in FIG. 1. The four layers are known as the link layer 102, network layer 104, transport layer 106 and application layer 108.

The link layer 102, sometimes called the data-link layer or network interface layer, normally includes the device driver (software) and the corresponding network interface (hardware). Together they handle all the hardware details of physically interfacing with the cable (or whatever type of media is being used). The media access control (MAC) layer is a sublayer of link layer 102. The MAC sublayer controls how devices on the network gain access to data and permission to transmit the data on a shared channel such as a local area network (LAN). The MAC layer uses MAC protocols and MAC addresses to ensure that signals sent from different stations on the shared channel do not collide.

The network layer 104 (sometimes called the Internet layer) handles the movement of packets around the network. Routing of packets, for example, takes place here. IP (Internet Protocol), ICMP (Internet Control Message Protocol), SCMP, and IGMP (Internet Group Management Protocol) are included in the network layer in the TCP/IP protocol suite.

The transport layer 106 provides a flow of data between two hosts, for the application layer 108, above. TCP lives on this layer and provides a reliable flow of data between two hosts. It is concerned with things such as dividing the data passed to it from the application into appropriately sized chunks for the network layer 104 below, acknowledging received packets, setting timeouts to make certain the other end acknowledges packets that are sent, and so on. Because reliable flow of data is provided by transport layer 106, the application layer 108 above it can ignore all of these details. User Datagram Protocol (UDP) also resides at the transport layer 106 and is a broadcast transport protocol typically used for streaming media, the Trivial File Transfer Protocol (TFTP), and is the generally accepted protocol for SNMP implementations, though an SNMP/TCP protocol is defined. UDP differs from TCP in that it does not guarantee packet delivery to the target; rather it is a requirement that the application layer 108 running on UDP must handle transmission and retransmission of the packetized data.

The application layer 108 handles the details of the particular application. There are many common TCP-UDP/IP applications: Telnet for remote login, FTP, the File Transfer Protocol, SMTP, the Simple Mail Transfer protocol, for electronic mail, SNMP, Simple Network Management Protocol, hyper text transfer protocol (HTTP), and many more.

SNMP (Simple Network Management Protocol) as defined by RFC-1157/STD-0015 [Case, Fedor, Schoffstall, and Davin, 1990] is a network monitoring, management and control protocol. SNMP is a management and control protocol that resides at the application layer 108. SNMP is used to collect data from nodes within a network concerning hardware and software performance as well as configuration and control activities. The data is passed from a variety of SNMP network elements to an SNMP manager that is used to oversee the network. SNMP has become the de facto standard of network management protocols and is widely used on all major IP platforms for network management.

The SNMP network elements can be any node that provides network communications using the Internet Protocol (IP) stack such as a router, a printer, telecommunications gear, and so forth. Software that runs the SNMP application in the network element is referred to as the SNMP Agent. The SNMP agent responds to queries from SNMP manager applications and is responsible for retrieving and updating local management information in response to requests from the SNMP manager. The agent may also notify the manager autonomously, known as a trap message, when a significant event or problem occurs. A manager is an SNMP application that generates queries to SNMP agent applications and receives responses and traps from SNMP agent applications. In all SNMP implementations, the manager and agent use SNMP to reference a Management Information Base (MIB) as specified in RFC-1213/STD-0017 [Rose and McCloghrie 1991], where both the manager and agent have identical copies of one or more MIBs. A MIB consists of common structures and an identification scheme used to reference the variables in the MIB. This scheme is called the Structure of Management Information (SMI) and is specified in RFC-1155 [Rose and McCloghrie 1990] and a second implementation in RFC-2578/STD-0058 [McCloghrie, Perkins, and Schoenwaelder 1999].

A fundamental requirement of an SNMP implementation is that the manager(s) and agent(s) each have a uniquely assigned IP address, which identifies each node on a TCP-UDP/IP network. IP addresses distinguish a device from all other devices on the Internet and must be obtained from a registration service (such as the Internet Assigned Numbers Authority-IANA). Because of the expense involved in obtaining and allocating IP addresses, it is desirable to avoid assignment of IP addresses wherever possible. Unfortunately, devices that do not have an IP address cannot communicate using SNMP or similar management protocol. It would thus be very useful to extend a monitoring, reporting and control protocol, such as SNMP, to non-IP addressed nodes. Embodiments of the present invention respond to this need.

### BRIEF DESCRIPTION OF THE DRAWING

FIG. 1 is an illustration of an example of the four layers normally considered to be a part of the TCP/IP protocol suite.

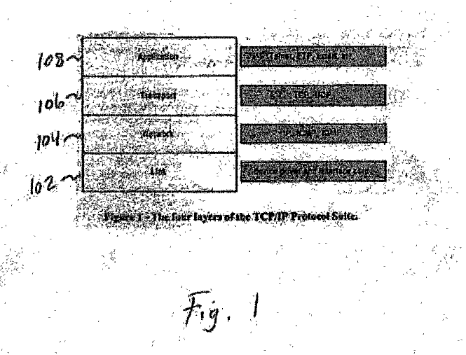

FIG. 2 is an illustration of an example of a layout of a packet communication between an SNMP Master and an SNMP Agent.

FIG. 3 is an illustration of one example of handling an SNMP request according to an embodiment of the present invention.

### DETAILED DESCRIPTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural and/or design changes may be made without departing from the scope of the present invention.

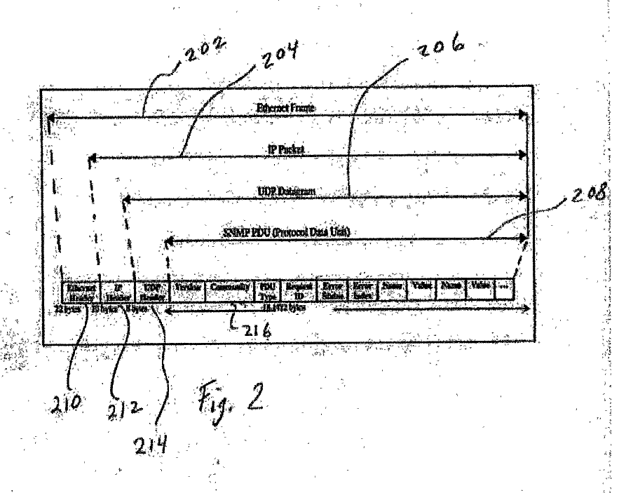

FIG. 2 shows a packet diagram of a typical packet communication between an SNMP Master and an SNMP Agent. The data in each SNMP message is encapsulated by one or more headers that define routing and addressing information in Ethernet frame 202. The outermost field is a header which is provided for routing and addressing and handling hardware details related to physical processing of the message over a cable or other media at link layer 102. In this example, since the message is encapsulated for transmission over an Ethernet medium it includes Ethernet header 210, which defines the beginning of Ethernet frame 202 and contains the source address and destination address of the Ethernet packet. A Token Ring or other link layer protocol may also be used depending on the implementation. The Ethernet source address contains the media access control (MAC) address of the device that generated the Ethernet packet, typically the MAC address of the network interface card (NIC) installed in the device. The MAC address is a unique identifier that is hard coded into the device to which it belongs at the time of manufacture. The destination address field of the Ethernet header contains the MAC address of the NIC installed in the device that will receive the Ethernet packet. When a properly addressed packet is received by a NIC, the NIC strips off the Ethernet header and trailer, leaving an IP packet 204 for network layer 104. The Network layer 104 will parse the IP packet and compare against registered TCP or UDP listener ports. If one is found, the Network Layer 104 will remove the IP header information and pass the TCP-UDP data up the stack to the Transport Layer 106. The Transport Layer will then determine if an Application Level 108 protocol has been registered to receive data on this protocol for the specified port. If an application exists, the Transport Layer 106 will remove the TCP-UDP header information and and pass the remaining data to application level 108. SNMP data is referred to as a Protocol Data Unit (PDU).

To achieve its goal of being simple, SNMP includes a limited number of management commands and responses in a PDU message 208. The manager issues Get, GetNext and Set messages, and the agent sends Response messages in reply to the Get GetNext or Set messages from the manager. In addition, as noted above, the agent may asynchronously transmit a Trap message in the event that an error on the device occurs that has an assigned trap message index.

Each SNMP PDU message 208 is divided into a number of fields. The Packet Community Field 216, of importance to embodiments of the present invention, provides a form of authentication which is checked by the recipient of the PDU 208 to make sure that the sender is allowed to perform the requested operation. In one example, the Packet Community Field 216 is a non-encrypted alphanumeric ASCII string. In applications where greater security may be required, encryption of the packet community field 216 may also be provided in modified versions of SNMP.

To authenticate a PDU, a receiving SNMP agent will compare the packet's community field against its locally stored community strings to allow or disallow access to the requested object's variable (name field). If the packet's PDU Type is GET and the community string matches the agent's read-only or read-write community string, the response packet will be identical to the received packet, except that each valid name field will be followed by a value field with the current value assigned to the object identified by the name field. If the packet's community string matches the Agent's read-write community string, than an SNMP GET request will yield the requested object's current value, and an SNMP SET request will modify and save the requested object's value as defined in the name/value fields, as well as return the requested value (which should match the value received in the SET request).

In order to extend the SNMP protocol to include both IP-based SNMP agents and non-IP-based SNMP agents there must be a way to include routing information for non-IP-based nodes, while at the same time retaining compatibility with existing commercially available SNMP Master application software. Community field 216 provides a vehicle for such routing information since it is a required field in all SNMP packets. Certain embodiments of the present invention thus utilize the community field 216 to provide an identifier for non-IP addressed machines. In one example, embodiments of the present invention provide for a non-alphanumeric delimiting character or sequence of characters, followed by an alphanumeric sequence such as a MAC number or address to uniquely identify a single network node in the community field 216 of an SNMP message 208.

Operation of examples of the present invention will now be described. Embodiments of the present invention require that at least one network node, running an SNMP Agent, has an IP address allocated to it. The one or more SNMP agents with IP addresses will act as a Gateway SNMP Agent.

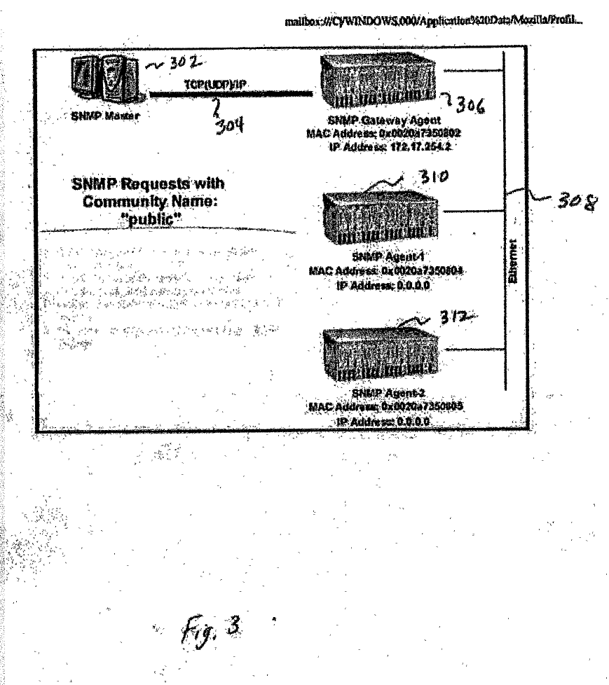

Referring to FIG. 3, an SNMP message is sent by SNMP master 302 over an IP network link 304 to SNMP gateway agent 306. SNMP Gateway Agent 306 is responsible for parsing each received SNMP packet to determine if the request has a valid community string in community field 216. If so, the community string is then further parsed for a known delimiter or marker. If the delimiter is found, the community string is finally parsed for a non-zero alphanumeric string to uniquely reference a network node. If both the delimiter is recognized, and the alphanumeric string uniquely identifies an external node (i.e., a node that is not the Gateway Agent 306 itself and may not have an IP address), the SNMP packet is then encapsulated within an implementation-specific Ethernet-level protocol packet (or other data link level encapsulization) to be routed over Ethernet link 308 to the appropriate remote node. In the example of FIG. 3 either external node 310 or external node 312 may be the ultimate recipient of the message. If no delimiter is found, or the alphanumeric string uniquely identifies the Gateway Agent 306, the SNMP request is processed by the Gateway Agent 306.

Any non-alphanumeric character may be used as a delimiter. For example, a colon character ‘:’ may be used as a delimiter. Following the delimiter, a unique identifier is provided. In one example, a globally unique MAC Address is used to identify the non-IP based devices. The MAC address is included after the delimiter in the community field of each SNMP packet so that the Gateway Agent can route the SNMP packet by encapsulating it within an appropriate link level protocol. If no delimiter is found, or the alphanumeric string uniquely identifies the Gateway Agent, the SNMP request is processed by Gateway Agent 306.

Upon receipt of the routed packet, receiving SNMP external agents 310 or 312 will process and respond to the SNMP request in the same manner as if the request had been directly targeted to it by specifying an IP address. The agent's response will be directed back to Gateway Agent 306 over Ethernet link 308 by encapsulating the response within the same implementation-specific Ethernet (or other data link)-level protocol, where it will then be routed back to the SNMP Master via SNMP/UDP/IP over IP link 304.

Implementation of this design mandates one requirement for the aforementioned asynchronously transmitted SNMP Trap messages. There exists no formal requirement for SNMP Master applications to resolve the originator of received Trap messages (i.e., defined as implementation-specific). However, the standard implementation is to use the originator's IP address that is included in all Trap message packets at Network Layer 104. Implementation of this patent design would incorrectly resolve the originator of the generating SNMP Agent to always be a Gateway SNMP Agent, as only a Gateway Agent can allocate and send an IP packet. Therefore, our solution provides that the first name/value field of all SNMP Trap messages (see FIG. 216) must contain the MAC Address of the originating SNMP Agent in the Value field, where the contents of the corresponding Name field are implementation-specific.

While there are many possible implementations and embodiments of the present invention, in one example, the present invention may be used to extend the SNMP protocol to include both IP-based SNMP agents and non-IP-based SNMP agents in a telecommunications system. Such a telecommunications system may include a number of telecommunications gear shelves connected serially via 10Base-2 coaxial cabling to comprise an MS-LAN (MultiShelf LAN) [Holt, PG-Plus MultiShelf LAN, 2000]. Each shelf contains a Management Unit card that would execute the SNMP Agent software. The present invention may also be used in any IP network of machines to extend a network management protocol to non-IP-addressed machines. The term “machine-readable medium” as used herein, refers to any medium capable of being accessed or read or by a machine, apparatus, system, or device, and includes, but is not limited to, wireless transmission media, wire, cable, or optical fiber, as well as magnetic, electronic or optical storage devices and media.

### Conclusion

A method and system for extending SNMP to non-IP type nodes has been disclosed. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. An SNMP protocol embodied in a machine readable media, comprising:
a community field for including an identifier for routing an SNMP message to a non-IP addressed node.

2. The SNMP protocol of claim 1, wherein the identifier comprises a MAC number.

3. The SNMP protocol of claim 2, further comprising a delimiter to mark the location of the identifier.

4. A system for extending SNMP protocol to one or more non-IP addressed nodes, comprising:
an SNMP gateway agent addressable by an IP address;
at least one non-IP addressed agent to receive SNMP messages; and
a process for routing SNMP messages to one or more non-IP addressed agents based on a unique identifier contained in the SNMP message.

5. A method for extending an SNMP protocol to one or more non-IP addressed nodes, comprising:
receiving an SNMP message comprising a community field at an IP-addressed gateway agent;
examining the SNMP message at the IP-addressed gateway agent to determine if the community field includes information for routing the message to a non-IP addressed node; and
routing the message to the non-IP addressed node, if any, specified in the community field.

6. The method of claim 5, wherein the information for routing comprises a MAC address.

7. The method of claim 5, wherein the community field comprises a delimiter.

8. The method of claim 7, wherein the delimiter comprises a non-alphanumeric character.

9. The method of claim 8, wherein the non-alphanumeric character comprises a colon.

10. A network system comprising:
an SNMP master;
an SNMP gateway agent; and
one or more non-IP addressed agents to receive SNMP messages from the SNMP master routed through the SNMP gateway agent.

11. The network system of claim 10, wherein the SNMP messages are routed to the non-IP addressed agents by a unique identifier in a predetermined SNMP message field.

12. The network system of claim 11, wherein the predetermined field of one or more SNMP messages comprises community field.

13. The network system of claim 11, wherein the community field comprises a MAC address.

14. A data structure embodied in a machine readable media, comprising:
a network management message;
an IP address for routing to a first recipient of the message; and
a field for a non-IP identifier associated with an ultimate recipient of the message;
wherein the network management message is routed by the first recipient to an ultimate recipient when a non-IP identifier associated with an ultimate recipient of the message is determined to be present.

15. A method for routing SNMP messages to non-IP addressed nodes of a network, the network comprising an SNMP master and at least one SNMP agent, the method comprising:
receiving a SNMP request by a first SNMP agent;
parsing the request to determine whether routing is required to a non-IP addressed agent;
handling the request by the first SNMP agent if no routing is required;
routing the request to the non-IP addressed agent if parsing the request determines that routing is required; and
generating a response to send to the SNMP master.

16. The method of claim 15 wherein the response is sent to the SNMP master through the first SNMP agent.

17. The method of claim 16 wherein the response is encapsulated within a link-level protocol used by the first SNMP agent, and routed back to the SNMP Master by an internet protocol address.

18. A method for routing network management messages to non-IP addressed nodes of a network, the network comprising a network management message master and at least one IP-addressed network management message gateway agent, the method comprising:
receiving a network management message request by the IP-addressed gateway agent;
parsing the request to determine whether routing is required to a non-IP addressed agent;
handling the request by the IP-addressed gateway agent if no routing is required;
routing the request to the non-IP addressed agent if parsing the request determines that routing is required; and
generating a response to send to the network management message master.

19. The method of claim 18 wherein the response is sent to the network management message master through the IP-addressed gateway agent.

20. The method of claim 19 wherein the response is encapsulated within a link-level protocol used by IP-addressed gateway agent, and routed back to network management message master by an IP.

21. The method of claim 20 wherein the link-level protocol is an Ethernet protocol.

22. A data structure embodied in a machine readable media, comprising:
a SNMP message;
an IP address for a first recipient of the SNMP message; and
a field parsable by the first recipient for a non-IP identifier associated with an ultimate recipient of the SNMP message;
wherein the SNMP message is routable by the first recipient to the ultimate recipient when the non-IP identifier is determined to be present.

23. A data structure embodied in a machine readable media, comprising:
a SNMP message;
an IP address for a first recipient of the SNMP message; and
a field for a non-IP identifier that uniquely identifies an ultimate recipient of the SNMP message;
wherein the SNMP message may is routable by the first recipient to the ultimate recipient when the non-IP identifier is determined to be present.

24. A data structure embodied in a machine readable media, comprising:
a SNMP trap message;
an IP address for a recipient of the SNMP message; and
a field for a non-IP identifier that uniquely identifies the sender of the SNMP trap message;
wherein the origin of the SNMP trap message is determinable by the recipient by parsing the non-IP identifier.

25. An SNMP protocol embodied in a machine readable media, comprising:
a first name/value field comprising a unique identifier for a non-IP addressed node.

26. The SNMP protocol of claim 25, wherein the identifier comprises a MAC number.

27. A method for routing a trap message from a non-IP addressed node of a network to a network management message master, the method comprising:
sending a trap message by the non-IP-addressed node to the network management message master comprising a non-IP addressed node identifier; and
parsing the trap message at the network management message master to determine from which non-IP addressed node the message originated.

28. The method of claim 27 wherein the non-IP addressed node identifier is included in a first name/value field of the trap message.

29. The method of claim 28 wherein the non-IP addressed node identifier comprises a MAC address.

30. A system for extending a network management message protocol to one or more non-IP addressed nodes, comprising:
a network management message gateway agent addressable by an IP address;
at least one non-IP addressed agent to receive network management messages; and
a process for routing network management messages to one or more non-IP addressed agents based on a unique identifier contained in the network management message.

31. A method for extending an IP network management message protocol to one or more non-IP addressed nodes, comprising:
receiving at an IP-addressed gateway agent an IP network management message comprising a predetermined non-IP address identifier field;
examining the IP network management message at the IP-addressed gateway agent to determine if the non-IP address identifier field includes information for routing the message to a non-IP addressed node; and
routing the message to the non-IP addressed node, if any, specified in the non-IP address identifier field.

32. The method of claim 31, wherein the information for routing comprises a MAC address.
